(19) United States
(12) Patent Application Publication
(10) Pub. No.: US 2015/0212349 A1
(43) Pub. Date: Jul. 30, 2015

(54) BLUE PHASE LIQUID CRYSTAL DISPLAY PANEL

(71) Applicant: Shenzhen China Star Optoelectronics Technology Co., Ltd., Shenzhen, Guangdong (CN)

(72) Inventor: Xinhui Zhong, Shenzhen (CN)

(73) Assignee: Shenzhen China Star Optoelectronics Technology Co., Ltd., Shenzhen, Guangdong (CN)

(21) Appl. No.: 14/241,063

(22) PCT Filed: Dec. 2, 2013
(86) PCT No.: PCT/CN2013/088357

§ 371 Date: Feb. 25, 2014

(30) Foreign Application Priority Data
Nov. 28, 2013 (CN) 201310627612.9

(51) Int. Cl. G02F 1/137; G02F 1/1343; G02F 1/1333; G02F 1/1368

(52) U.S. Cl. CPC G02F 1/137; G02F 1/1368; G02F 1/134309; G02F 1/133345; G02F 2001/13793

(57) ABSTRACT

The present invention provides a blue phase liquid crystal display panel, which includes: a first substrate (10), where the first substrate (10) includes a first transparent substrate (11), multiple sets of first electrodes (40) that are formed on the first transparent substrate (11) and are parallel to each other, an insulation layer (15) that is formed on the first transparent substrate (11) and the multiple sets of first electrodes (40), and multiple sets of second electrodes (50) that are formed on the insulation layer (15) and are parallel to each other, the first electrodes (40) and the second electrodes (50) defining therebetween an included angle; a second substrate (20); and a blue phase liquid crystal layer (30). The blue phase liquid crystal display panel of the present invention uses two layers or more than two layers of differently-directed parallel electrodes to form inter-layer alternating horizontal electric fields to drive blue phase liquid crystal molecules, so as to induce phase difference of the blue phase liquid crystal molecules in different directions, thereby shortening the response time of the blue phase liquid crystal display panel, reducing hysteresis effect of the blue phase liquid crystal display panel, and reducing the driving voltage of the blue phase liquid crystal display panel.

### BACKGROUND OF THE INVENTION

1. Field of the Invention

The present invention relates to the field of liquid crystal display technology, and in particular to a blue phase liquid crystal display panel that increases response speed, reduces hysteresis effect, and reduces driving voltage.

2. The Related Arts

Liquid crystal displays (LCDs) have a variety of advantages, such as thin device body, low power consumption, and being free of radiation, and are thus widely used. Most of the liquid crystal displays that are currently available in the market are backlighting liquid crystal displays, which comprise a liquid crystal display panel and a backlight module. The operation principle of the liquid crystal display panel is that, with liquid crystal molecules interposed between two parallel glass substrates, application of electricity to glass substrates is selectively carried out to control the liquid crystal molecules to change direction in order to refract out light emitting from the backlight module for generating images.

The liquid crystal display panel comprises a color filter (CF) substrate, a thin-film transistor (TFT) substrate, liquid crystal (LC) interposed between the CF substrate and the TFT substrate, and a sealant and the manufacturing process generally comprises: a front stage of array process (including thin film, yellow light, etching, and film stripping), an intermediate stage of cell process (including laminating the TFT substrate and the CF substrate), and a rear stage of assembling process (including mounting of drive ICs and printed circuit board). The front stage of array process generally forms the TFT substrate in order to control the movement of the liquid crystal molecules. The intermediate stage of cell process generally introduces the liquid crystal between the TFT substrate and the CF substrate. The rear stage of assembling process generally integrates the drive ICs and combining the printed circuit board to achieve driving of the liquid crystal molecules to rotate for displaying images.

An active TFT-LCD (Thin-Film Transistor Liquid Crystal Display) display device has been recently under fast development and wide applications. The TFT-LCD display panels that are available in the mainstream market can be classified in three categories, including TN (twisted nematic)/STN (super twisted nematic), IPS (in-plane switching)/FFS (fringe field switching), and VA (Vertical Alignment). Although the principles that they adopt to control liquid crystal displaying are different, the basic structures of these three types of liquid crystal display panels are similar to each other. Referring to FIG. 1, which is a schematic view showing the structure of a conventional TFT-LCD display panel, the conventional TFT-LCD display panel generally comprises, in a layer stacked arrangement from top to bottom, an upper polarizer 100, a color filter substrate 110, a liquid crystal layer 120, a thin-film transistor substrate 130, and a lower polarizer 140, the layers being stacked, sequentially from top to bottom, to constitute a display panel.

To achieve full color displaying, a common practice is to make a CF substrate on a glass plate of a liquid crystal display panel (which is often a glass plate that is set opposite to the glass plate of a TFT substrate but can alternatively be the glass plate of the TFT substrate) through processes of coating, exposure, and development, so as to make use of the principle of spatial color mixture to fulfill full color displaying. However, the CF substrate allows only lights of a portion of wavebands to pass therethrough and consequently, the intensity of light, after passing through the CF substrate, is reduced to only around 33% of the original level. This is one of the causes that make the optical efficiency of the conventional LCD relatively low. With the needs for development of the LCD technology and the green environmental protection being deeply implanted in the minds of human beings, developing high optical efficiency TFT-LCD becomes increasingly important. Field sequential color liquid crystal display (FSC-LCD) is one of the high optical efficiency liquid crystal displays. It is a liquid crystal display device that requires no color filter substrate and it makes use of sub-screens of red, green, and blue, as well as persistence of vision of human eyes, to form a full color image on retinae by means of timed color mixture. The FSC-LCD is achieved with the principle illustrated in FIG. 2, wherein color images (frames) are grouped as red image fields 220, green image fields 240, and blue image fields 260 according to timing sequence and then the three images (fields) are switched fast and sequentially to constitute a color image (frame) 200. The FSC-LCD has various advantages, such as high optical efficiency, high resolution, and low cost.

A high quality FSC-LCD requires the liquid crystal has an extremely high response speed. However, the currently commonly used liquid crystal display panels, such as TN/STN, IPS/FFS, and VA modes, cannot completely meet the need of the FSC-LCD for response speed. Thus, it needs to find out or develop a liquid crystal display panel having an extremely high response speed and a blue phase liquid crystal display panel is considered one of the liquid crystal display panels that have the potential to realize the FSC-LCD. This is because the blue phase liquid crystal display panel has a response speed in the order of sub-milliseconds and may provide a remarkable advantage over the conventional liquid crystal displays if being used in an FSC-LCD. However, heretofore, the blue phase liquid crystal displaying technology suffers certain problems, such as excessively high driving voltage and showing a hysteresis effect. Thus, the blue phase liquid crystal displaying technology requires further improvement.

### SUMMARY OF THE INVENTION

An object of the present invention is to provide a blue phase liquid crystal display panel, wherein two layers of parallel electrodes of which the directions define a predetermined angle are arranged on a first substrate of the blue phase liquid crystal display panel in order to shorten the response time of the blue phase liquid crystal display panel, reduce the hysteresis effect of the blue phase liquid crystal display panel, and reduce the driving voltage of the blue phase liquid crystal display panel.

Another object of the present invention is to provide a blue phase liquid crystal display panel, wherein a layer of parallel electrodes is arranged on a third substrate of the blue phase liquid crystal display panel and another layer of parallel electrodes that are set at a predetermined angle with respect to the direction of the parallel electrodes of the third substrate is arranged on a fourth substrate in order to shorten the response time of the blue phase liquid crystal display panel, reduce the hysteresis effect of the blue phase liquid crystal display panel, and reduce the driving voltage of the blue phase liquid crystal display panel.

To achieve the above objects, the present invention provides a blue phase liquid crystal display panel, which comprises:

a first substrate, wherein the first substrate comprises a first transparent substrate, multiple sets of first electrodes that are formed on the first transparent substrate and are parallel to each other, an insulation layer that is formed on the first transparent substrate and the multiple sets of first electrodes, and multiple sets of second electrodes that are formed on the insulation layer and are parallel to each other, the first electrodes and the second electrodes defining therebetween an included angle;

a second substrate, wherein the second substrate is arranged opposite to the first substrate; and

a blue phase liquid crystal layer, wherein the blue phase liquid crystal layer is hermetically sealed between the first substrate and the second substrate.

Each set of the first electrodes comprises a first positive electrode and a first negative electrode that is arranged parallel to the first positive electrode and each set of the second electrodes comprises a second positive electrode and a second negative electrode that is arranged parallel to the second positive electrode; the first positive electrode, the second positive electrode, the first negative electrode, and the second negative electrode are all in the form of straight strips; and the first substrate is a TFT (Thin-film Transistor) substrate.

The included angle defined between the first electrodes and the second electrodes is 60-120°. The first positive electrodes and the second positive electrodes form therebetween an included angle of 60-120°. The first negative electrodes and the second negative electrodes form therebetween an included angle of 60-120°.

The included angle defined between the first electrodes and the second electrodes is 80-100°. The first positive electrodes and the second positive electrodes form therebetween an included angle of 80-100°. The first negative electrodes and the second negative electrodes form therebetween an included angle of 80-100°.

The included angle defined between the first electrodes and the second electrodes is 90°. The first positive electrodes and the second positive electrodes form therebetween an included angle of 90°. The first negative electrodes and the second negative electrodes form therebetween an included angle of 90°.

The present invention also provides a blue phase liquid crystal display panel, which comprises:

a first substrate, wherein the first substrate comprises a first transparent substrate, multiple sets of first electrodes that are formed on the first transparent substrate and are parallel to each other, an insulation layer that is formed on the first transparent substrate and the multiple sets of first electrodes, and multiple sets of second electrodes that are formed on the insulation layer and are parallel to each other, the first electrodes and the second electrodes defining therebetween an included angle;

a second substrate, wherein the second substrate is arranged opposite to the first substrate; and

a blue phase liquid crystal layer, wherein the blue phase liquid crystal layer is hermetically sealed between the first substrate and the second substrate;

wherein each set of the first electrodes comprises a first positive electrode and a first negative electrode that is arranged parallel to the first positive electrode and each set of the second electrodes comprises a second positive electrode and a second negative electrode that is arranged parallel to the second positive electrode; the first positive electrode, the second positive electrode, the first negative electrode, and the second negative electrode are all in the form of straight strips; and the first substrate is a TFT (Thin-film Transistor) substrate.

The included angle defined between the first electrodes and the second electrodes is 60-120°. The first positive electrodes and the second positive electrodes form therebetween an included angle of 60-120°. The first negative electrodes and the second negative electrodes form therebetween an included angle of 60-120°.

The included angle defined between the first electrodes and the second electrodes is 80-100°. The first positive electrodes and the second positive electrodes form therebetween an included angle of 80-100°. The first negative electrodes and the second negative electrodes form therebetween an included angle of 80-100°.

The included angle defined between the first electrodes and the second electrodes is 90°. The first positive electrodes and the second positive electrodes form therebetween an included angle of 90°. The first negative electrodes and the second negative electrodes form therebetween an included angle of 90°.

The present invention further provides a blue phase liquid crystal display panel, which comprises:

a third substrate, wherein the third substrate comprises a second transparent substrate and multiple sets of third electrodes that are formed on the second transparent substrate and are to each other;

a fourth substrate, wherein the fourth substrate is arranged opposite to the third substrate and the fourth substrate comprises a third transparent substrate and multiple sets of fourth electrodes that are formed on the third transparent substrate and are parallel to each other, the third electrodes and the fourth electrodes defining therebetween an included angle; and

a blue phase liquid crystal layer, wherein the blue phase liquid crystal layer is hermetically sealed between the third substrate and the fourth substrate;

the fourth electrodes being formed on a surface of the third transparent substrate adjacent to the blue phase liquid crystal layer.

Each set of the third electrodes comprises a third positive electrode and a third negative electrode that is arranged parallel to the third positive electrode and each of the fourth electrodes comprises a fourth positive electrode and a fourth negative electrode that is arranged parallel to the fourth positive electrode; the third positive electrode, the fourth positive electrode, the third negative electrode, and the fourth negative electrode are all in the form of straight strips; and the third substrate is a TFT (Thin-Film Transistor) substrate and the fourth substrate is a TFT substrate.

The included angle defined between the third electrodes and the fourth electrodes is 60-120°. The third positive electrodes and the fourth positive electrodes form an included angle of 60-120°. The third negative electrodes and the fourth negative electrodes form an included angle of 60-120 °.

The included angle defined between the third electrodes and the fourth electrodes is 80-100°. The third positive electrodes and the fourth positive electrodes form an included angle of 80-100°. The third negative electrodes and the fourth negative electrodes form an included angle of 80-100 °.

The included angle defined between the third electrodes and the fourth electrodes is 90°. The third positive electrodes and the fourth positive electrodes form an included angle of 90°. The third negative electrodes and the fourth negative electrodes form an included angle of 90°.

The efficacy of the present invention is that the present invention provides a blue phase liquid crystal display panel, which comprises two layers or more than two layers of differently-directed parallel electrodes to form inter-layer alternating horizontal electric fields to drive blue phase liquid crystal molecules, so as to induce phase difference of the blue phase liquid crystal molecules in different directions, thereby shortening the response time of the blue phase liquid crystal display panel, reducing hysteresis effect of the blue phase liquid crystal display panel, and reducing the driving voltage of the blue phase liquid crystal display panel to make it applicable to a field sequential color liquid crystal display device for providing a field sequential color liquid crystal display device of high quality.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing the structure of a conventional TFT-LCD (Thin-Film Transistor Liquid Crystal Display) display panel;

FIG. 2 is a schematic view illustrating the principle of achieving a field sequential color liquid crystal display;

FIG. 3 is a schematic view showing the structure of a blue phase liquid crystal display panel according to a preferred embodiment of the present invention;

FIG. 4 is a cross-sectional view taken along line A-A of FIG. 3;

FIG. 5 is a cross-sectional view taken along line B-B of FIG. 3;

FIG. 6 is a schematic view showing the structure of a blue phase liquid crystal display panel according to another preferred embodiment of the present invention;

FIG. 7 is a cross-sectional view taken along line C-C of FIG. 6; and

FIG. 8 is a cross-sectional view taken along line D-D of FIG. 6.

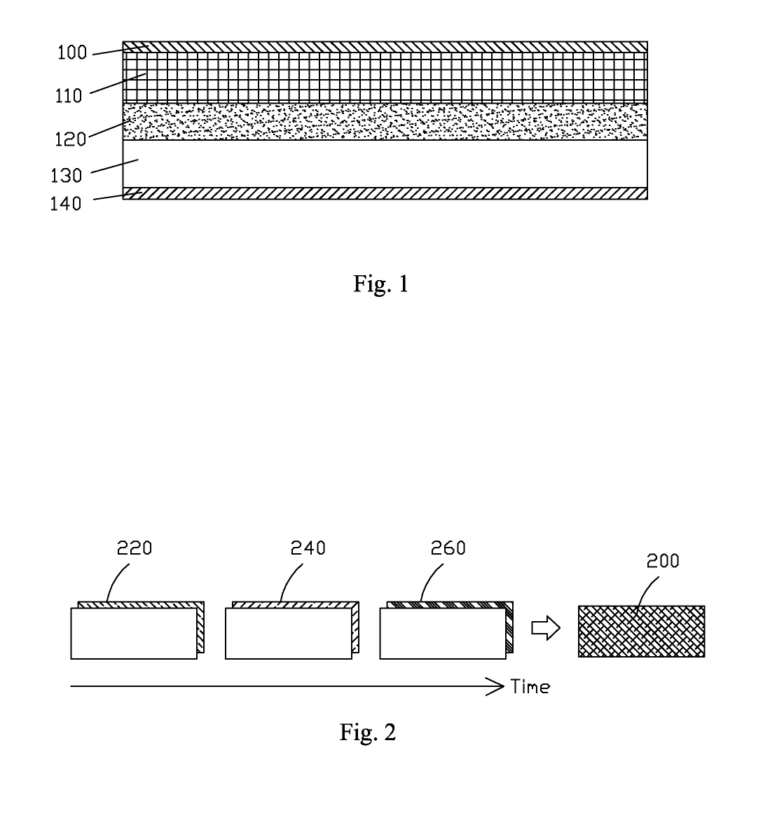

### DETAILED DESCRIPTION OF THE PREFERRED EMBODIMENTS

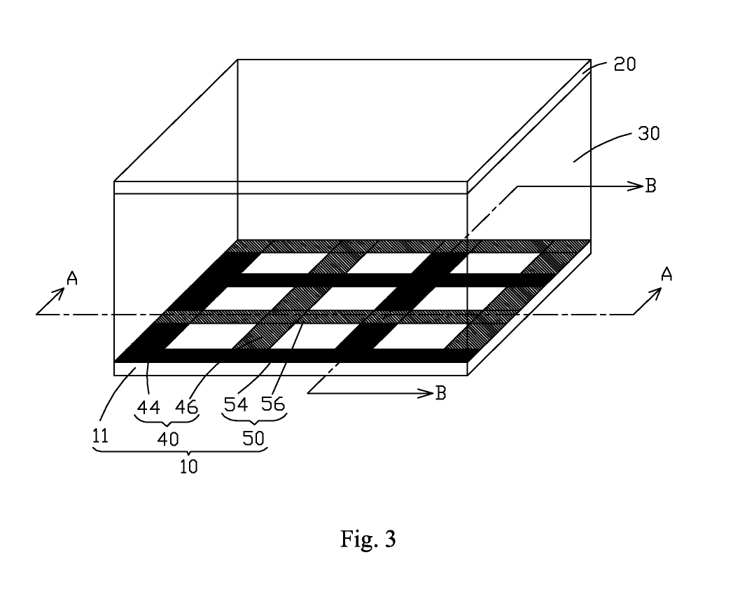

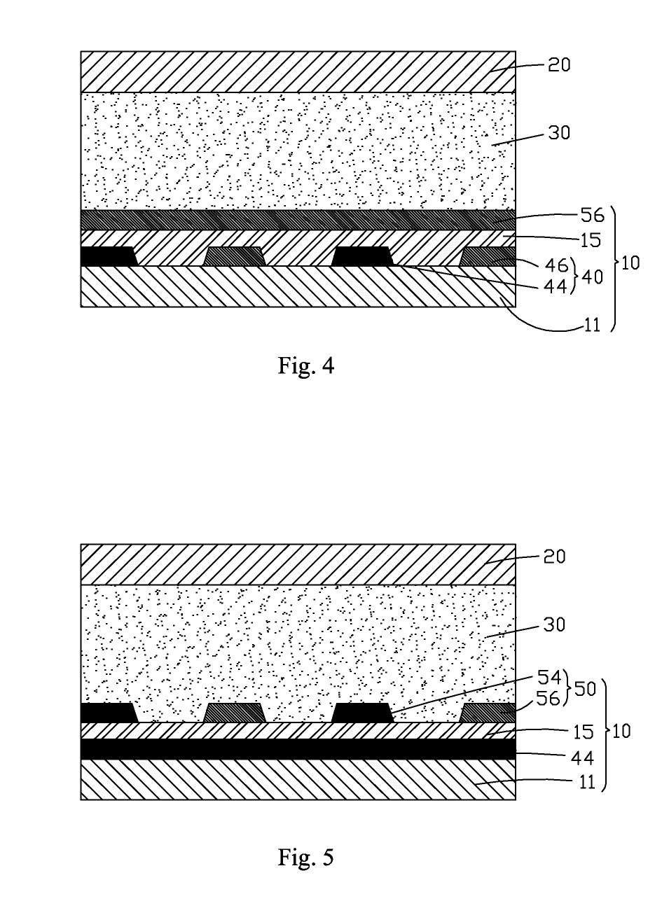

Referring to FIG. 3, which is a schematic view showing the structure of a blue phase liquid crystal display panel according to a preferred embodiment of the present invention, with additional reference being had to FIGS. 4 and 5, the present invention provides a blue phase liquid crystal display panel, which comprises a first substrate 10, a second substrate 20 and a blue phase liquid crystal layer 30. Preferably, the first substrate 10 is a TFT (Thin-Film Transistor) substrate.

The first substrate 10 comprises a first transparent substrate 11, multiple sets of first electrodes 40 that are formed on the first transparent substrate 11 and are parallel to each other, an insulation layer 15 that is formed on the first transparent substrate 11 and the multiple sets of first electrodes 40, and multiple sets of second electrodes 50 that are formed on the insulation layer 15 and are parallel to each other. In the instant embodiment, the first electrodes 40 and the second electrodes 50 are both formed on the first substrate 10 but at different layers. The insulation layer 15 is arranged between the first electrodes 40 and the second electrodes 50 in order to isolate and space the first electrodes 40 and the second electrodes 50 from each other. The first transparent substrate 11 is preferably a glass substrate or a plastic substrate.

The second substrate 20 is arranged opposite to the first substrate 10 and comprises a transparent substrate. The transparent substrate is preferably a glass substrate or a plastic substrate.

The blue phase liquid crystal layer 30 is hermetically sealed between the first substrate 10 and the second substrate 20. The blue phase liquid crystal layer 30 comprises a plurality of blue phase liquid crystal molecules.

The first electrodes 40 and the second electrodes 50 define an included angle therebetween. The included angle is an include angle that is formed between the first electrodes 40 and the second electrodes 50b if the first electrodes 40 are shifted upwards to the same plane as the second electrodes 50. The included angle formed between the first electrodes 40 and the second electrodes 50 is 60-120°, preferably 80-100°, and more preferably 90°.

Each set of the first electrodes 40 comprises a first positive electrode 44 and a first negative electrode 46 that is arranged parallel to the first positive electrode 44. Each set of the second electrodes 50 comprises a second positive electrode 54 and a second negative electrode 56 that is arranged parallel to the second positive electrode 54. The first positive electrodes 44, the second positive electrodes 54, the first negative electrodes 46 and the second negative electrodes 56 are all in the form of straight strips. The first positive electrode 44 and the second positive electrode 54 (or the first negative electrode 46 and the second negative electrode 56) form therebetween an included angle of 60-120°, preferably 80-100°, and more preferably 90°. The included angle is an included angle formed between the first positive electrode 44 (or the first negative electrode 46) and the second positive electrode 54 (or the second negative electrode 56), if the first positive electrode 44 (or the first negative electrode 46) is shifted upwards to the same plane as the second positive electrode 54 (or the second negative electrode 56).

In an attempt to drive the liquid crystal molecules contained in the blue phase liquid crystal layer 30, a voltage is applied to the first positive electrodes 44 and the first negative electrodes 46 of the first electrodes 40 and the second positive electrodes 54 and the second negative electrodes 56 of the second electrodes 50. Since the first positive electrodes 44 and the first negative electrodes 46 of the first electrodes 40 and the second positive electrodes 54 and the second negative electrodes 56 of the second electrodes 50 are arranged in an intersecting manner, inter-layer alternating horizontal electric fields are generated. The horizontal electric fields induce phase differences of the blue phase liquid crystal molecules in different directions, thereby shortening the response time of the blue phase liquid crystal display panel and reducing hysteresis effect of the blue phase liquid crystal display panel. Further, since two layers of parallel electrodes that are set in different directions are used to drive the liquid crystal molecules, the driving voltage of the blue phase liquid crystal display panel can be reduced.

In the instant embodiment, two layers of parallel electrodes that are set in different directions are arranged on one of the substrates of a liquid crystal display panel and the electrodes of each layer comprise positive electrodes and negative electrodes, but not limited thereto. It is also possible to arrange multiple layers of parallel electrodes at different directions.

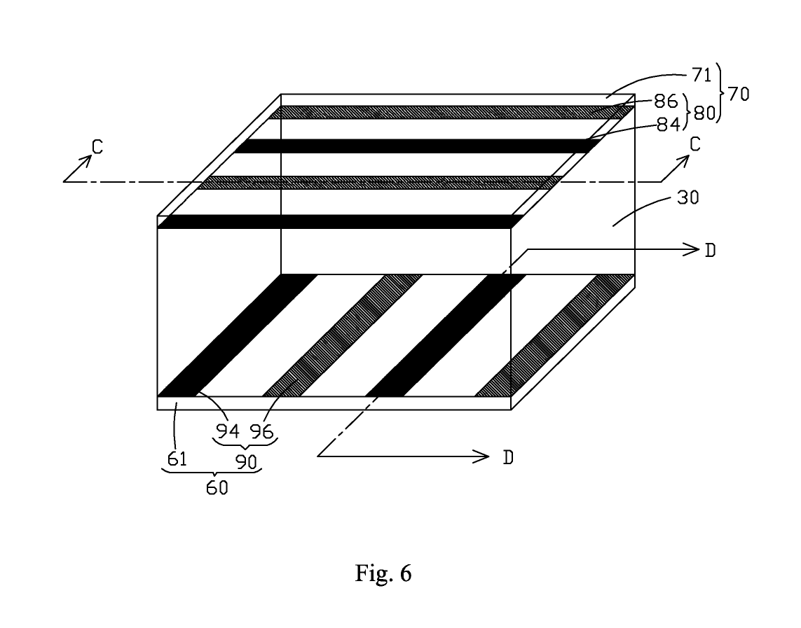

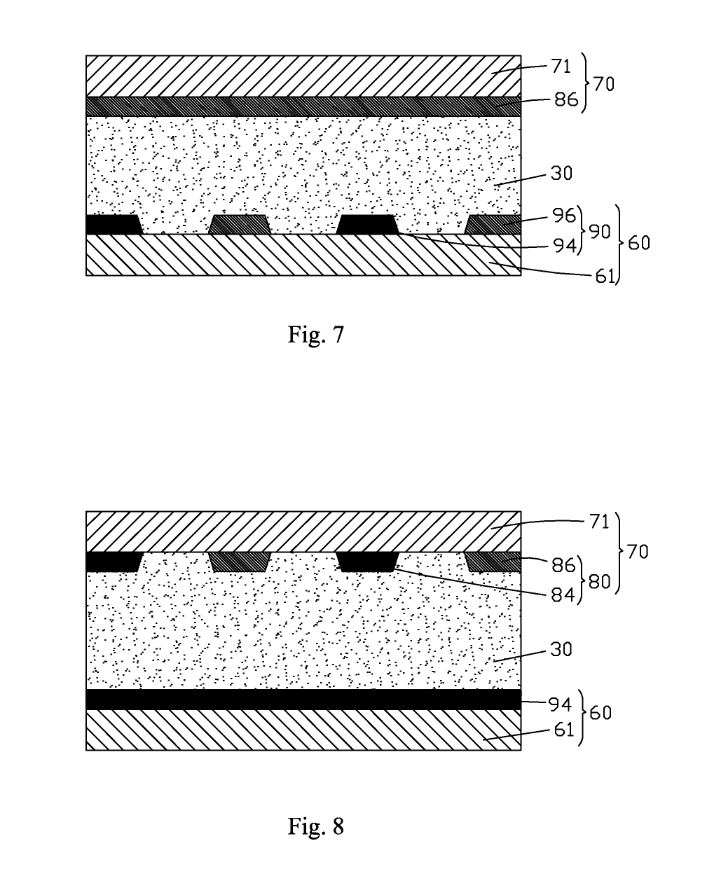

Referring to FIG. 6, which is a schematic view showing the structure of a blue phase liquid crystal display panel according to another preferred embodiment of the present invention, with additional reference being hand to FIGS. 7 and 8, the present invention also provides a blue phase liquid crystal display panel, which comprises a third substrate 60, a fourth substrate 70, and a blue phase liquid crystal layer 30. Preferably, the third substrate 60 is a TFT substrate and the fourth substrate 70 is also a TFT substrate.

The third substrate 60 comprises a second transparent substrate 61 and multiple sets of third electrodes 90 that are formed on the second transparent substrate 61 and are parallel to each other. The second transparent substrate 61 is preferably a glass substrate or a plastic substrate. In the instant embodiment, the insulation layer is omitted from the third substrate 60 so as to help achieve an advantage of making the blue phase liquid crystal display panel light and thin.

The fourth substrate 70 is arranged opposite to the third substrate 60 and comprises a third transparent substrate 71 and multiple sets of fourth electrodes 80 that are arranged on the third transparent substrate 71 and are parallel to each other. The fourth electrodes 80 are arranged on the surface of the third transparent substrate 71 adjacent to the blue phase liquid crystal layer 30. The third transparent substrate 71 is preferably a glass substrate or a plastic substrate.

In the instant embodiment, the third electrodes 90 and the fourth electrodes 80 are arranged on different substrates in an intersecting manner. The third electrodes 90 and the fourth electrodes 80 define an included angle therebetween. The included angle is an included angle that is formed between the third electrodes 90 and the fourth electrodes 80 if the third electrodes 90 are shifted upwards to the same plane as the fourth electrodes 80. The included angle formed between the third electrodes 90 and the fourth electrodes 80 is 60-120°, preferably 80-100°, and more preferably 90°.

The blue phase liquid crystal layer 30 is hermetically sealed between the third substrate 60 and the fourth substrate 70. The blue phase liquid crystal layer 30 comprises a plurality of blue phase liquid crystal molecules.

Each set of the third electrodes 90 comprises a third positive electrode 94 and a third negative electrode 96 that is arranged parallel to the third positive electrode 94. Each set of the fourth electrodes 80 comprises a fourth positive electrode 84 and a fourth negative electrode 86 that is arranged parallel to the fourth positive electrode 84. The third positive electrodes 94, the fourth positive electrodes 84, the third negative electrodes 96, and the fourth negative electrodes 86 are all in the form of straight strips. The third positive electrode 94 and the fourth positive electrode 84 (or the third negative electrode 96 and the fourth negative electrode 86) form therebetween an included angle of 60-120°, preferably 80-100°, and more preferably 90°. The included angle is an included angle formed between the third positive electrode 94 (or the third negative electrode 96) and the fourth positive electrode 84 (or the fourth negative electrode 86), if the third positive electrode 94 (or the third negative electrode 96) is shifted upward to the same plane as the fourth positive electrode 84 (or the fourth negative electrode 86).

In an attempt to drive the liquid crystal molecules contained in the blue phase liquid crystal layer 30, a voltage is applied to the third positive electrode 94 and the third negative electrode 96 of the third electrodes 90 and the fourth positive electrode 84 and the fourth negative electrode 86 of the fourth electrodes 80. Since the third positive electrode 94 and the third negative electrode 96 of the third electrodes 90 and the fourth positive electrode 84 and the fourth negative electrode 86 of the fourth electrodes 80 are arranged in an intersecting manner, inter-layer alternating horizontal electric fields are generated. The horizontal electric fields induce phase differences of the blue phase liquid crystal molecules in different directions, thereby shortening the response time of the blue phase liquid crystal display panel and reducing hysteresis effect of the blue phase liquid crystal display panel. Further, since two layers of parallel electrodes that are set in different directions are used to drive the liquid crystal molecules, the driving voltage of the blue phase liquid crystal display panel can be reduced.

In the instant embodiment, one layer of parallel electrodes is arranged on one of the substrates of the liquid crystal display panel and another layer of parallel electrodes that are in a direction different from the parallel electrodes of the opposite substrate is arranged on another one of the substrates the liquid crystal display panel. The electrodes of each layer comprise positive electrodes and negative electrodes, but not limited thereto. It is also possible to arrange multiple layers of parallel electrodes at different directions respectively on the two substrates of the liquid crystal display panel.

In summary, the present invention provides a blue phase liquid crystal display panel, which comprises two layers or more than two layers of differently-directed parallel electrodes to form inter-layer alternating horizontal electric fields to drive blue phase liquid crystal molecules, so as to induce phase difference of the blue phase liquid crystal molecules in different directions, thereby shortening the response time of the blue phase liquid crystal display panel, reducing hysteresis effect of the blue phase liquid crystal display panel, and reducing the driving voltage of the blue phase liquid crystal display panel to make it applicable to a field sequential color liquid crystal display device for providing a field sequential color liquid crystal display device of high quality.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A blue phase liquid crystal display panel, comprising:
a first substrate, wherein the first substrate comprises a first transparent substrate, multiple sets of first electrodes that are formed on the first transparent substrate and are parallel to each other, an insulation layer that is formed on the first transparent substrate and the multiple sets of first electrodes, and multiple sets of second electrodes that are formed on the insulation layer and are parallel to each other, the first electrodes and the second electrodes defining therebetween an included angle;
a second substrate, wherein the second substrate is arranged opposite to the first substrate; and
a blue phase liquid crystal layer, wherein the blue phase liquid crystal layer is hermetically sealed between the first substrate and the second substrate.

2. The blue phase liquid crystal display panel as claimed in claim 1, wherein each set of the first electrodes comprises a first positive electrode and a first negative electrode that is arranged parallel to the first positive electrode and each set of the second electrodes comprises a second positive electrode and a second negative electrode that is arranged parallel to the second positive electrode; the first positive electrode, the second positive electrode, the first negative electrode, and the second negative electrode are all in the form of straight strips; and the first substrate is a TFT (Thin-film Transistor) substrate.

3. The blue phase liquid crystal display panel as claimed in claim 2, wherein the included angle defined between the first electrodes and the second electrodes is 60-120°, the first positive electrodes and the second positive electrodes forming therebetween an included angle of 60-120°, the first negative electrodes and the second negative electrodes forming therebetween an included angle of 60-120°.

4. The blue phase liquid crystal display panel as claimed in claim 3, wherein the included angle defined between the first electrodes and the second electrodes is 80-100°, the first positive electrodes and the second positive electrodes forming therebetween an included angle of 80-100°, the first negative electrodes and the second negative electrodes forming therebetween an included angle of 80-100°.

5. The blue phase liquid crystal display panel as claimed in claim 4, wherein the included angle defined between the first electrodes and the second electrodes is 90°, the first positive electrodes and the second positive electrodes forming therebetween an included angle of 90°, the first negative electrodes and the second negative electrodes forming therebetween an included angle of 90°.

6. A blue phase liquid crystal display panel, comprising:
a first substrate, wherein the first substrate comprises a first transparent substrate, multiple sets of first electrodes that are formed on the first transparent substrate and are parallel to each other, an insulation layer that is formed on the first transparent substrate and the multiple sets of first electrodes, and multiple sets of second electrodes that are formed on the insulation layer and are parallel to each other, the first electrodes and the second electrodes defining therebetween an included angle;
a second substrate, wherein the second substrate is arranged opposite to the first substrate; and
a blue phase liquid crystal layer, wherein the blue phase liquid crystal layer is hermetically sealed between the first substrate and the second substrate;
wherein each set of the first electrodes comprises a first positive electrode and a first negative electrode that is arranged parallel to the first positive electrode and each set of the second electrodes comprises a second positive electrode and a second negative electrode that is arranged parallel to the second positive electrode; the first positive electrode, the second positive electrode, the first negative electrode, and the second negative electrode are all in the form of straight strips; and the first substrate is a TFT (Thin-film Transistor) substrate.

7. The blue phase liquid crystal display panel as claimed in claim 6, wherein the included angle defined between the first electrodes and the second electrodes is 60-120°, the first positive electrodes and the second positive electrodes forming therebetween an included angle of 60-120°, the first negative electrodes and the second negative electrodes forming therebetween an included angle of 60-120°.

8. The blue phase liquid crystal display panel as claimed in claim 7, wherein the included angle defined between the first electrodes and the second electrodes is 80-100°, the first positive electrodes and the second positive electrodes forming therebetween an included angle of 80-100°, the first negative electrodes and the second negative electrodes forming therebetween an included angle of 80-100°.

9. The blue phase liquid crystal display panel as claimed in claim 8, wherein the included angle defined between the first electrodes and the second electrodes is 90°, the first positive electrodes and the second positive electrodes forming therebetween an included angle of 90°, the first negative electrodes and the second negative electrodes forming therebetween an included angle of 90°.

10. A blue phase liquid crystal display panel, comprising:
a third substrate, wherein the third substrate comprises a second transparent substrate and multiple sets of third electrodes that are formed on the second transparent substrate and are to each other;
a fourth substrate, wherein the fourth substrate is arranged opposite to the third substrate and the fourth substrate comprises a third transparent substrate and multiple sets of fourth electrodes that are formed on the third transparent substrate and are parallel to each other, the third electrodes and the fourth electrodes defining therebetween an included angle; and
a blue phase liquid crystal layer, wherein the blue phase liquid crystal layer is hermetically sealed between the third substrate and the fourth substrate;
the fourth electrodes being formed on a surface of the third transparent substrate adjacent to the blue phase liquid crystal layer.

11. The blue phase liquid crystal display panel as claimed in claim 10, wherein each set of the third electrodes comprises a third positive electrode and a third negative electrode that is arranged parallel to the third positive electrode and each of the fourth electrodes comprises a fourth positive electrode and a fourth negative electrode that is arranged parallel to the fourth positive electrode; the third positive electrode, the fourth positive electrode, the third negative electrode, and the fourth negative electrode are all in the form of straight strips; and the third substrate is a TFT (Thin-Film Transistor) substrate and the fourth substrate is a TFT substrate.

12. The blue phase liquid crystal display panel as claimed in claim 11, wherein the included angle defined between the third electrodes and the fourth electrodes is 60-120°, the third positive electrodes and the fourth positive electrodes forming an included angle of 60-120°, the third negative electrodes and the fourth negative electrodes forming an included angle of 60-120°.

13. The blue phase liquid crystal display panel as claimed in claim 12, wherein the included angle defined between the third electrodes and the fourth electrodes is 80-100°, the third positive electrodes and the fourth positive electrodes forming an included angle of 80-100°, the third negative electrodes and the fourth negative electrodes forming an included angle of 80-100°.

14. The blue phase liquid crystal display panel as claimed in claim 13, wherein the included angle defined between the third electrodes and the fourth electrodes is 90°, the third positive electrodes and the fourth positive electrodes forming an included angle of 90°, the third negative electrodes and the fourth negative electrodes forming an included angle of 90°.
